(19) United States
(12) Patent Application Publication
(10) Pub. No.: US 2009/0319971 A1
(43) Pub. Date: Dec. 24, 2009

(54) METHOD OF VERIFYING LAYOUT OF SEMICONDUCTOR INTEGRATED CIRCUIT DEVICE

(75) Inventor: Akihito SAKAKIDANI, Kanagawa (JP)

Correspondence Address: YOUNG & THOMPSON, 209 Madison Street, Suite 500, Alexandria, VA, 22314, US

(73) Assignee: NEC ELECTRONICS CORPORATION, KANAGAWA (JP)

(21) Appl. No.: 12/484,431

(22) Filed: Jun. 15, 2009

(30) Foreign Application Priority Data
Jun. 23, 2008 (JP) 2008-162984

(51) Int. Cl. G06F 17/50

(52) U.S. Cl. 716/5

(57) ABSTRACT

An exemplary aspect of an embodiment of the present Invention is a method of verifying a layout for a semiconductor integrated circuit device including: segmenting a layout of a semiconductor integrated circuit device into a plurality of local regions; calculating a ratio for each local region, the ratio being the area of a region in which an element isolation layer is exposed on a semiconductor wafer surface forming the semiconductor integrated circuit device to the area of the local region; and verifying the layout of the semiconductor integrated circuit device based on the ratio.

### BACKGROUND

1. Field of the Invention

The present invention relates to a method of verifying a layout of d semiconductor integrated circuit device.

2. Description of the Related Art

Lamp annealing is mainly used in semiconductor processing for the 90 nm generation and later as a method for activating impurity atoms injected into a source-drain section of a transistor. Herein a region of the semiconductor chip surface in which an STI (Shallow Trench Isolation) insulation film is not covered by a gate electrode section and a diffusion layer section is termed an STI exposure section. STI is a type of element isolation layer. It has been reported that large deviation in an area ratio of the STI exposure section in a chip causes a large deviation in the temperature on the chip during lamp annealing (I. Ahsan eat al. “RTA-driven intra-die variations in stage delay, and parametric sensitivities for 65 nm technology”, IEEE Symposium on VLSI Technology, Digest of Technical Papers, 2006, p 170-171). This effect is thought to result from the difference between the emissivity of the STI exposure section composed of SiO₂ and the emissivity of the gate section and the diffusion layer section composed of Si.

FIG. 8 shows the steps in manufacturing a general LSI up to the lamp annealing step. Firstly after formation of a diffusion layer, a gate electrode is formed. Then an oxide film, that is to say, a sidewall is formed on the side wall of the gate electrode. After injection of ions into the source-drain section, lamp annealing is performed.

The surface of the semiconductor wafer (chip) during lamp annealing is constituted by the STI exposure section composed of SiO₂ and the diffusion layer section and the gate electrode section composed of Si. Normally annealing processes progress from the wafer surface as a result of the lamp heat source. At each position on the wafer surface, a local difference in the area ratio of the STI exposure section composed of SiO₂ which has a different emissivity to Si causes a difference in the absorbing heat capacity.

Consequently during lamp annealing, deviations in local temperatures on the wafer surface increase and consequently there are greater deviations in the characteristics at each position of the device in the chip (in particular, MOS transistor elements or silicide block resistance elements). Such deviation increases finally have an adverse effect on LSI productivity and increase manufacturing costs.

Japanese Unexamined Patent Application Publication No. 2005-353905 proposes a method of automatic optimization of the respective area ratios of the gate and diffusion layer for the purpose of improving productivity by stabilization of etching and ion injection.

### SUMMARY

However in Japanese Unexamined Patent Application Publication No. 2005-353905, the area ratios of the gate and diffusion layer are independently calculated using layout data and the respective area ratios are designed to fall within a standard range. The standard range for area ratios is determined according to etching conditions or CMP process conditions. In Japanese Patent Unexamined Application Publication No. 2005-353905, since the area ratio of the STI exposure section is not considered, temperature fluctuations in the impurity activation lamp annealing step above cannot be suppressed.

A first exemplary aspect of an embodiment of the present invention is a method of verifying a layout for a semiconductor integrated circuit device including: segmenting a layout of a semiconductor integrated circuit device into a plurality of local regions; calculating a ratio for each local region, the ratio being the area of a region in which an element isolation layer is exposed on a semiconductor wafer surface forming the semiconductor integrated circuit device to the area of the local region; and verifying the layout of the semiconductor integrated circuit device based on the ratio.

According to an exemplary aspect of the present invention, a local area ratio of an exposure section of an element isolation layer can be automatically optimized so that temperature deviations do not occur in a lamp annealing step.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 shows an STI section, diffusion layer section and gate section seen from the wafer surface;

FIG. 2 shows simulation conditions;

FIG. 3 is a graph showing simulation calculation results for the area and STI local area ratio and temperature difference;

FIG. 4 is a graph showing simulation calculation results for the area and STI local area ratio and temperature difference;

FIG. 5 shows the steps in a layout verification method according to an exemplary embodiment of the present invention;

FIG. 6 is an image of 3×3 imposition processing;

FIG. 7 is an image of segmentation into local regions extracting a local area ratio under respective local area conditions; and

FIG. 8 shows the step in manufacture of a semiconductor.

### DETAILED DESCRIPTION OF THE EXEMPLARY EMBODIMENTS

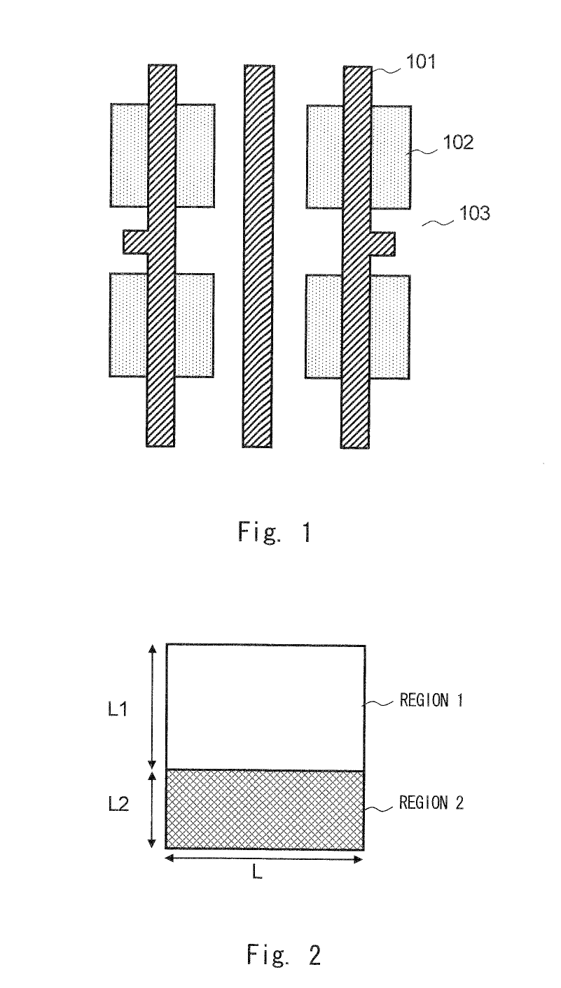

Firstly the results of a simulation will be discussed with respect to temperature deviations in a lamp annealing process resulting from variation in an area ratio of an STI exposure section. As shown in FIG. 1, a region of a semiconductor chip surface in which an STI (Shallow Trench Isolation) insulation film is not covered by a gate electrode section 101 and a diffusion layer section 102 (when expressed in mask data, a region which is not an “OR” region for gate electrode data and diffusion layer data) is termed an STI exposure section 103. As shown in FIG. 2, in a local region on an LSI chip, an area ratio of an STI exposure section is assumed to have two regions, region 1 and region 2. A temperature difference ΔT was simulated with respect to the region 1 and the region 2 in a lamp annealing step for cases where an area ratio difference of an STI exposure section in the region 1 and the region 2 was varied and then the sizes of the region 1 and the region 2 were varied.

As shown in FIG. 2, the area of the rectangular region 1 and region 2 is defined respectively as L×L1, L×L2. In other words, the area ratio of region 1 and region 2 respectively varies proportionally to variation in L1 and L2.

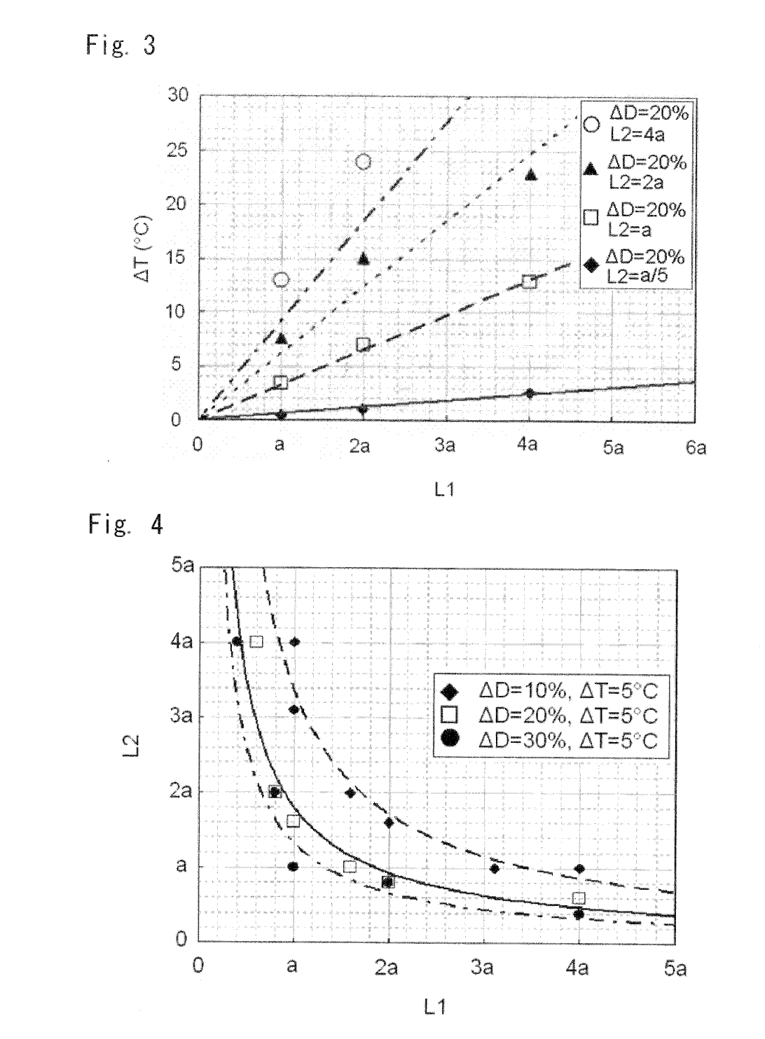

FIG. 3 shows the calculation results of a temperature difference ΔT (vertical axis) in region 1 and region 2 with respect to L1 (horizontal axis) when the absolute value of the difference in the area ratio of the STI exposure area in region 1 and region 2 is 20%. The four approximation lines show variation in L2. It can be seen that the temperature difference in region 1 and region 2 increases according to increase in L1 and L2.

FIG. 4 shows the results of extracting L1 and L2 from the same simulation results at the temperature difference ΔT=5° C. Furthermore FIG. 4 shows the simulation results when the area ratio difference is 10% and 30%. The temperature difference ΔT can be seen to depend not only on the area ratio of the STI exposure section in the region 1 and the region 2 but also on the local region 1 and region 2 area.

From the above description, the temperature deviation ΔT has the correlation shown below with respect to respective area ratios D1, D2 of the STI exposure section in region 1 and region 2 and the local region 1 and region 2 areas A1, A2.

ΔT∝|D×A1−D2×A2|

These results show that if positions for maximum and minimum local area ratios are identified in a local area range based on a layout of an LSI chip, temperature deviations during a lamp annealing step produced on an LSI chip, in other words a wafer, can be identified in advance. That is to say, the inventors have discovered that temperature deviations in a lamp annealing step can be suppressed if a layout is optimizing using the relationship between an area and a local area ratio difference of an STI exposure section.

The present invention is premised on a proper understanding of device performance characteristics and temperature behavior during lamp annealing steps and provides a method of layout verification enabling suppression of temperature deviation in lamp annealing steps during semiconductor manufacturing processes entailing differing generations or specifications.

### First Exemplary Embodiment

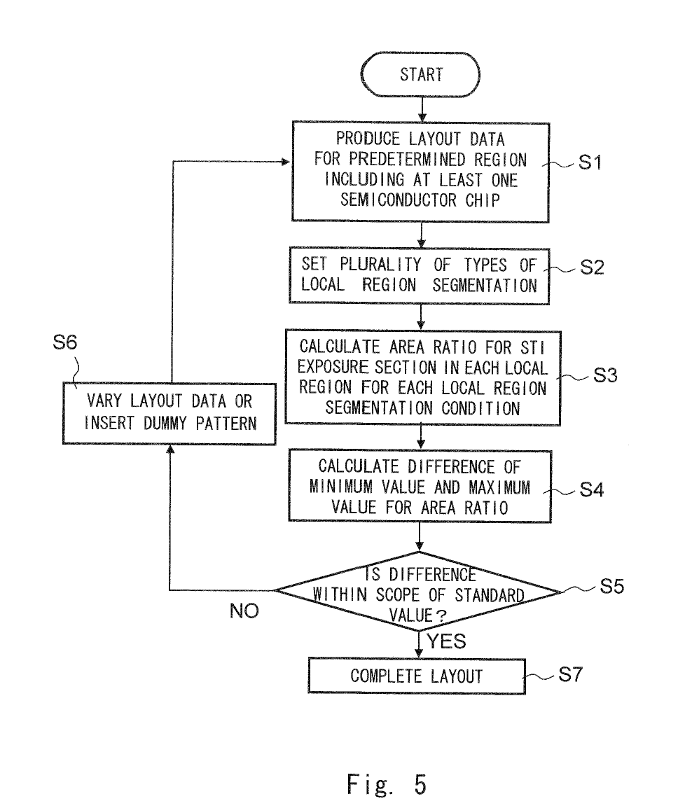

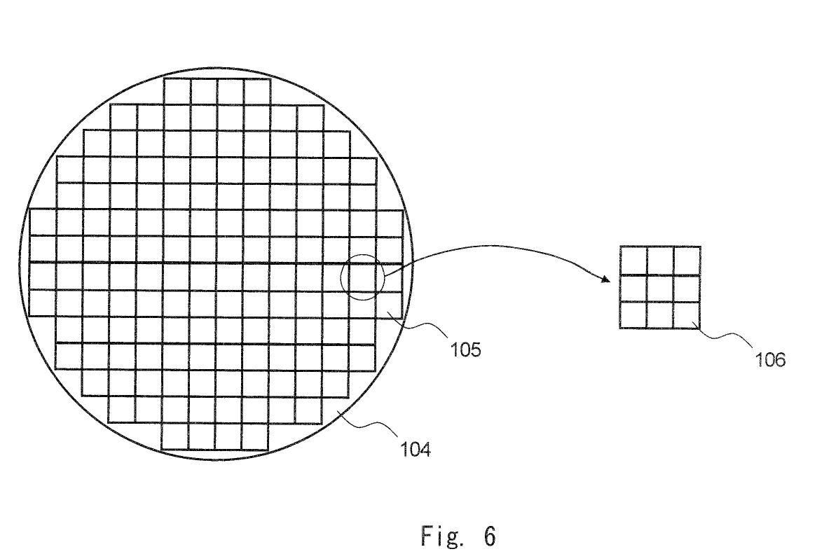

Exemplary embodiments of the present invention will be described below with reference to the drawings. FIG. 5 shows the steps in a layout verification method according to an exemplary embodiment of the present invention. Firstly layout data for a predetermined region including at least one semiconductor chip is produced (S1). More precisely, data of each mask layer for manufacture onto a wafer is automatically produced from layout data of one chip. As shown in FIG. 6, impositioning as desired can be performed in the production of mask layer data. Normally a single chip contains a functional circuit region and a scribe region (dicing region) The scribe region is positioned between two chips. Various specific check patterns are disposed in the scribe region. The characteristics of elements forming the functional circuit are estimated by measuring the specific check patterns. Consequently when the “characteristics” of a transistor for a specific check pattern differ from the “characteristics” of a transistor forming a functional circuit, for example, in practice, it is no longer possible to evaluate the characteristics of the transistor forming the functional circuit. Alternatively, feedback of the results of specific check patterns for specific improvement of transistors in functional circuits is not possible. Therefore, optimization including scribe regions is preferably performed, if possible at greater than or equal to a 3×3 imposition, by determining optimal lamp annealing conditions through analyzing (calculating an area ratio as described hereafter) the center chip including a four-sided scribe region. FIG. 6 shows an example in which a semiconductor chip 106 has a 3×3=9 imposition in a mask 105 for the manufacture of a semiconductor device in a semiconductor wafer 104.

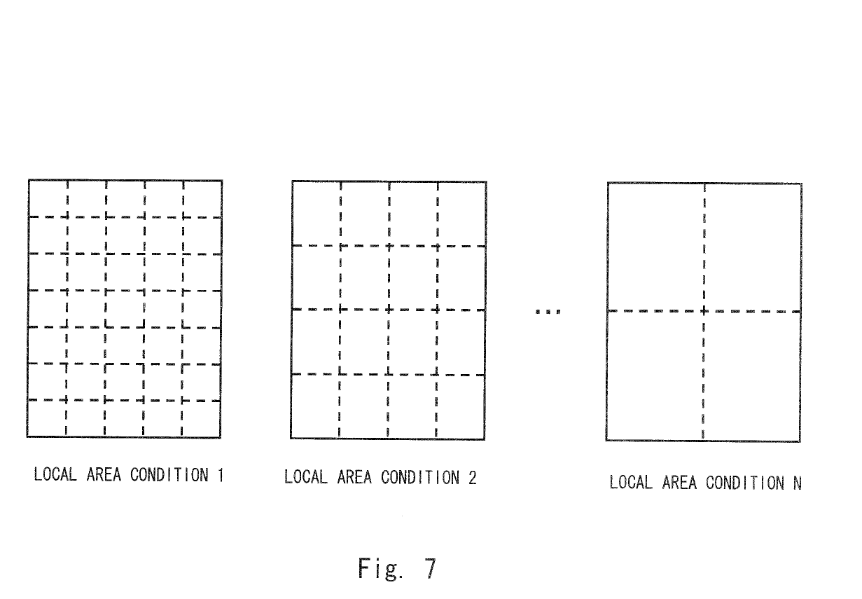

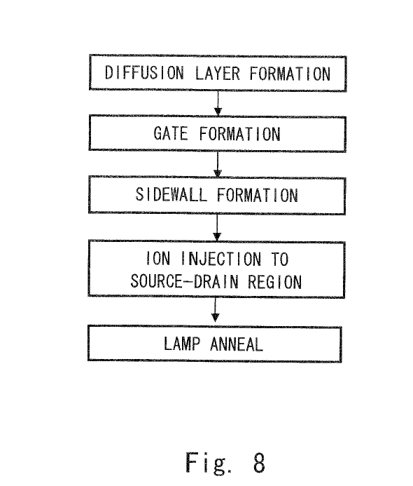

Next as shown in FIG. 7, in each process of semiconductor manufacture, a plurality of types of local region segmentation condition settings are provided to inhibit temperature deviations during impurity activation annealing steps (S2). That is to say, as shown in FIG. 7, a one-chip region is segmented by N conditions into a plurality of local regions.

Next respective local area ratios for STI exposure sections are calculated in each local region for each local region segmentation condition (S3) More precisely, a local area ratio for an STI exposure section which is a region in which an STI insulation film is not covered by the gate electrode section and the diffusion layer section is extracted by the mask layer calculation based on the mask layer data.

For example, as shown in FIG. 7, a single-chip region is segmented into 5×7=35 local regions under a local area condition 1, into 4×4=16 local regions under a local area condition 2, and into 2×2=4 local regions under a local area condition N. Automatic calculation time is preferably reduced by use of as few range conditions N determined at this time as possible.

Next as shown in Table 1, a maximum value and a minimum value under the respective local area conditions are extracted from the local area ratio for the STI exposure section extracted in each local region under the respective local area conditions. The absolute value of the difference is automatically calculated for all combinations of minima and maxima (S4).

For example, under the local area condition 1 as shown in FIG. 7, a local area ratio for an STI exposure section is extracted for each 5×7=35 local region and a maximum value Dmax1 and a minimum value Dmin1 are extracted from the local area ratio of the 35 STI exposure sections. In the same manner, under the local area condition 2 as shown in FIG. 7, a local area ratio for an STI exposure section is extracted for each 4×4=16 local region and a maximum value Dmax2 and a minimum value Dmin2 are extracted from the local area ratio of the 16 STI exposure sections. Hereafter in the same manner, under the local area condition N as shown in FIG. 7, a local area ratio for an ST1 exposure section is extracted for each 2×2=4 local region and a maximum value DmaxN and a minimum value DminN are extracted from the local area ratio of the 4 STI exposure sections.

TABLE 1

| | Local Area Ratio of STI Exposure Section | |
|---|---|---|
| | Maximum Value (%) | Minimum Value (%) |
| Local area condition 1 | Dmax1 | Dmin1 |
| Local area condition 2 | Dmax2 | Dmin2 |
| . | . | . |
| . | . | . |
| . | . | . |
| Local area condition N | DmaxN | DminN |

Next as shown in FIG. 2, the calculated difference (for example, ΔD_{N}=|DmaxN−DminN|) is automatically checked to see whether the area ratio difference is less than or equal to a standard value (S5). The standard value for the area ratio difference is determined in order to suppress temperature deviations (fluctuations) based on the performance characteristics of the lamp annealing device used in the annealing step for impurity activation in a given semiconductor manufacturing process. In Table 2, the standard values are not stated as precise values and all values are merely noted as ** %.

TABLE 2

| Difference ΔD | Standard Value |
|---|---|
| \|Dmax1 − Dmin1\| | ** % |
| \|Dmax1 − Dmin2\| | ** % |
| . | . |
| . | . |
| . | . |
| \|Dmax1 − DminN\| | ** % |
| \|Dmax2 − Dmin1\| | ** % |
| . | . |
| . | . |
| . | . |
| \|Dmax2 − DminN\| | ** % |
| . | . |
| . | . |
| . | . |
| \|DmaxN − Dmin1\| | ** % |
| . | . |
| . | . |
| . | . |
| \|DmaxN − DminN\| | ** % |

When the area ratio difference is less than or equal to the standard value (S5 YES), it is determined that no problems exist on the layout design, and the layout is completed (S7) Herein a value being in the range of the standard value must satisfy the following three conditions.
(1) When the area ratio is maximum in an area in which the area of the local region is smallest and the area ratio is minimum in an area in which the area of the local region is largest, |max−min| is in the range of the standard value.
(2) When the area ratio is minimum in an area in which the area of the local region is smallest and the area ratio is maximum in an area in which the area of the local region is largest, |max−min| is in the range of the standard value.
(3) The difference |max−min| of the maximum value and the minimum value of the area ratio in a local region of the same area is in the range of the standard value.

On toe other hand, when the area ratio difference is greater than or equal to the standard value (S5 NO), a local region for the maximum value or the minimum value is searched with reference to the local area condition at greater than or equal to the standard value. It is preferred that searching of the local area ratio should be adapted to enable extraction of coordinate information in order to specify the local region. After searching, a dummy pattern (dummy pattern including the gate section and the diffusion layer section) is inserted or the layout pattern is varied for reverification in order to satisfy the standard in the local region (S6). When preparing the dummy pattern, it is preferred that a number of types of dummy patterns having different local area ratios should be prepared in advance so that a dummy pattern satisfying the standard is automatically disposed based on the result of the step S4.

As described above, a maximum value and a minimum value for the local area ratio of an STI exposure section are extracted under a plurality of local area conditions based on the layout of an LSI chip. The difference between the two values is compared with a standard value in order to optimize the layout. In this manner, temperature deviations during a lamp annealing step can be suppressed and it is possible to improve LSI productivity. The present embodiment has used the example of a local area ratio in an STI exposure section. However naturally it is possible to obtain the same result using a local area ratio of a section other than an STI exposure section.

The optimal conditions for the area ratio or local area ratio of the present invention may be varied according to the difference in gate electrode materials (for example, the emissivity in a metallic gate is large) or the characteristics of a lamp annealing device (especially, wavelength of a light source). However it goes without saying that the invention can be simply adapted to various processes.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A method of verifying a layout for a semiconductor integrated circuit device comprising:
segmenting a layout of a semiconductor integrated circuit device into a plurality of local regions;
calculating a ratio for each local region, the ratio being the area of a region in which an element isolation layer is exposed on a semiconductor wafer surface forming the semiconductor integrated circuit device to the area of the local region; and
verifying the layout of the semiconductor integrated circuit device based on the ratio.

2. The method of verifying a layout for a semiconductor integrated circuit device according to claim 1, wherein:
a region of the layout of the semiconductor integrated circuit device is segmented into local regions under first and second segmentation condition having mutually different numbers of segments in the segmenting; and
the ratio for the respective first and second segmentation conditions is extracted in the calculating.

3. The method of verifying a layout for a semiconductor integrated circuit device according to claim 1, wherein:
a difference of a maximum value and a minimum value for the ratio is calculated in the calculating; and
the layout for the semiconductor integrated circuit device based on the difference is verified in the verifying.

4. The method of verifying a layout for a semiconductor integrated circuit device according to claim 3, further comprising revising the layout for the semiconductor integrated circuit device when the value of the difference is outside a range of a predetermined standard value.

5. The method of verifying a layout for a semiconductor integrated circuit device according to claim 1, wherein the ratio is a ratio used during a lamp annealing step.

6. The method of verifying a layout for a semiconductor integrated circuit device according to claim 1, wherein the element isolation layer comprises SiO₂.

7. A method of verifying a layout for a semiconductor integrated circuit device comprising:
segmenting a predetermined region including at least one semiconductor chip into N local regions (where N is an integer greater than or equal to 2);
calculating a ratio for each of the N local regions, the ratio being the area of a region in which layout data does not exist for either of a diffusion layer and a gate electrode layer of the surface of a semiconductor chip to the area of the local region;
calculating a difference between a minimum value and a maximum value of the ratio; and
when the difference of the minimum value and the maximum value of the ratio is outside a range of a predetermined value, inserting dummy patterns for either or both of the diffusion layer and the gate electrode layer, or varying the layout data for either or both of the diffusion layer and the gate electrode layer.

8. A method of verifying a layout for a semiconductor integrated circuit device comprising:
setting a first local region segmentation condition for segmenting a predetermined region including at least one semiconductor chip into N1 local regions (where N1 is an integer greater than or equal to 2);
setting a second local region segmentation condition for segmenting into N2 local regions which is a different value from N1 (where N2 is an integer greater than or equal to 2);
setting a third local region segmentation condition for segmenting into N3 local regions which is a different value from N1 and N2 (where N3 is an integer greater than or equal to 2);
calculating a ratio for each of the first, second, and third local region segmentation conditions, the ratio being the area of a region in which layout data does not exist for either of a diffusion layer and a gate electrode layer of the surface of a semiconductor chip to the area of the local region;
calculating a difference between a minimum value and a maximum value of the ratio under the respective local region segmentation conditions;
calculating respectively a difference between the minimum value and the maximum value of the ratio under the first and second, first and third, and second and third local region segmentation conditions; and
when a combination is produced in which the difference of a minimum value and a maximum value of the ratio is outside the range of a predetermined value, for the larger area of the local region, inserting dummy patterns for either or both of a diffusion layer and a gate electrode layer, or varying the layout data for either or both of a diffusion layer and a gate electrode layer.

9. The method of verifying a layout and a method for revising a layout for a semiconductor integrated circuit device according to claim 7, wherein the ratio is a ratio of an element isolation insulation region and an OR region of gate electrode layer data and diffusion layer data in the local region.

10. The method of verifying a layout and a method for revising a layout for a semiconductor integrated circuit device according to claim 8, wherein the ratio is a ratio of an element isolation insulation region and an OR region of gate electrode layer data and diffusion layer data in the local region.

11. The method of verifying a layout for a semiconductor integrated circuit device according to claim 7, wherein the predetermined value is determined based on conditions for lamp annealing.

12. The method of verifying a layout for a semiconductor integrated circuit device according to claim 8, wherein the predetermined value is determined based on conditions for lamp annealing.
